(19) United States
(12) Patent Application Publication
(10) Pub. No.: US 2009/0110619 A1
(43) Pub. Date: Apr. 30, 2009

(54) Apparatus for manufacturing metal nanoparticles

(75) Inventors: Young-Il Lee, Anyang-si (KR); Dong-Hoon Kim, Seongnam-si (KR); Kwi-Jong Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/149,835

(22) Filed: May 8, 2008

(30) Foreign Application Priority Data
Oct. 26, 2007 (KR) 10-2007-0108469

(51) Int. Cl. B01J 19/00

(52) U.S. Cl. 422/307

(57) ABSTRACT

An apparatus for manufacturing metal nanoparticles is disclosed. The apparatus includes: a precursor supply unit configured to supply a precursor solution for metal nanoparticles, a transport device configured to transport the precursor solution, a heating unit connected with the precursor supply unit and configured to heat the precursor solution to a temperature range in which a production of metal nanoparticles occurs, and a cooling unit connected with the heating unit and configured to collect and cool metal nanoparticles produced at the heating unit, where the cooling unit includes: a channel, a tube surrounding the channel, and a circulator configured to supply a coolant to the tube.

### CROSS-REFERENCE TO RELATED APPLICATIONS

This application claims the benefit of Korean Patent Application No. 10-2007-0108469 filed with the Korean Intellectual Property Office on Oct. 26, 2007, the disclosure of which is incorporated herein by reference in its entirety.

### BACKGROUND

1. Technical Field

The present invention relates to an apparatus for manufacturing metal nanoparticles, more particularly to an apparatus for manufacturing metal nanoparticles capable of continuously synthesizing metal nanoparticles in large quantities.

2. Description of the Related Art

Due to the unique properties provided by nanometer-sized particles, the application of metal nanoparticles is expected to extend to various fields of industry, including electronic components, coatings, condensers, magnetic tape, paint, etc., as conductive materials or recording materials. Accordingly, the demand for metal nanoparticles is rapidly increasing, leading to extensive research efforts aimed at mass producing metal nanoparticles.

In general, metal nanoparticles are manufactured by a variety of synthesis methods. Examples may include vapor phase methods, in which the vapor of metals evaporated at high temperatures is supplied into the atmosphere and made to collide with gas molecules, which may then be rapidly cooled to form fine particles; and liquid phase methods, in which a reducing agent is added to a solution containing metal ions, so that the metal ions may be reduced. Other examples may include solid phase methods and mechanical methods, etc.

Liquid phase methods are more economical and have simpler processes, compared to other synthesis methods, and entail reaction conditions that are easy to prepare. As such, liquid phase methods have a relatively wide range of application.

In continuously manufacturing nanoparticles using a liquid phase method, methods according to the related art may not require post-treatment, due to the small amount of nanoparticles obtained. Even in cases where large-scale synthesis methods are used, there is still a need for a detailed process that allows continuous post-treatment.

### SUMMARY

An aspect of the invention provides an apparatus for manufacturing metal nanoparticles that is coupled with a cooling device.

Another aspect of the invention provides an apparatus for manufacturing metal nanoparticles, which includes: a precursor supply unit configured to supply a precursor solution for metal nanoparticles, a transport device configured to transport the precursor solution, a heating unit connected with the precursor supply unit and configured to heat the precursor solution to a temperature range in which a production of metal nanoparticles occurs, and a cooling unit connected with the heating unit and configured to collect and cool metal nanoparticles produced at the heating unit, where the cooling unit includes: a channel, a tube surrounding the channel, and a circulator configured to supply a coolant to the tube.

A temperature controller, which can be configured to measure and control a temperature of the coolant, may additionally be coupled to the cooling unit.

A vibration device may further be coupled to the tube.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram illustrating an apparatus for manufacturing metal nanoparticles according to an embodiment of the present invention.

### DETAILED DESCRIPTION

The apparatus for manufacturing metal nanoparticles according to certain embodiments of the invention will be described below in more detail with reference to the accompanying drawings. Those components that are the same or are in correspondence are rendered the same reference numeral regardless of the figure number, and redundant explanations are omitted.

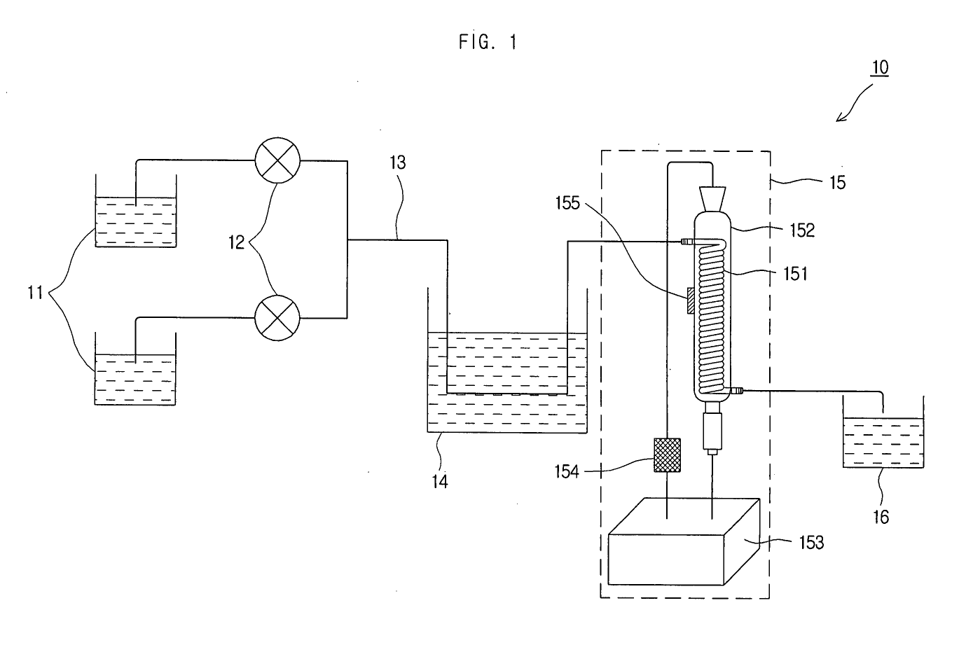

FIG. 1 is a schematic diagram illustrating an apparatus for manufacturing metal nanoparticles according to an embodiment of the present invention. In FIG. 1, there are illustrated an apparatus 10 for manufacturing metal nanoparticles, precursor supply units 11, transport devices 12, lines 13, a heating unit 14, a cooling unit 15, a channel 151, a tube 152, a circulator 153, a temperature controller 154, a vibrator 155, and a collector unit 16.

A precursor supply unit 11 may store a precursor solution for the metal nanoparticles.

The precursor solution stored in the precursor supply units 11 can contain metal salts, a reducing agent, and a dispersing agent, etc. According to the reaction conditions and the type of particles desired, the solution can be a single solution or solutions of two or more types. In order to facilitate the dissolving of the precursor material, the precursor supply unit may maintain a particular temperature range for the precursor solution, which can be 30 to 50° C., for example. To maintain a uniform solution, the precursor supply unit 11 may further include a stirring device, capable of stirring the precursor solution. The precursor solution does not have to be prepared inside the precursor supply unit 11 itself, and can be prepared beforehand in a separate container to be injected into the precursor supply unit 11 later.

The precursor supply units 11 may continuously transfer the precursor solution to the heating unit 14, by way of the transport devices 12. The precursor supply units 11 and the heating unit 14 can be connected by lines 13. The lines 13 can have the form of tubes that connect the components of the apparatus 10 for manufacturing metal nanoparticles.

The heating unit 14 can be shaped as a channel. The diameter of the channel can be between 1 mm and 50 mm. In certain cases, the diameter can be between 5 mm and 40 mm. Any of a variety of materials can be used for the channel as necessary, such as glass, metal, plastic, alloys, etc.

The heating unit 14 may provide the zone where the temperature of the precursor solution is raised to a value at which a reduction reaction occurs. An appropriate heating temperature can be selected in correspondence to the type of particles, the type of precursor material, and the type of solvent, from a temperature range of 70 to 400° C. If the heating temperature is below 70° C., the reduction reaction of the precursor material may not proceed smoothly, whereas if the heating temperature is over 400° C., the temperature may exceed the boiling point of the solvent used in the precursor solution, which can cause an increase in the internal pressure of the heating unit and lead to a risk of bursting.

The metal nanoparticles produced in the heating unit 14 may be cooled inside a cooling unit 15, and may undergo the post-treatment processes of cooling and aging. The major components of the cooling unit 15 may include a helical channel 151 through which the metal nanoparticles may travel, a tube 152 which covers the exterior of the helical channel 151, and a circulator 153 which supplies a cooling liquid to the tube 152.

The channel 151 can have a helical shape. The helical channel 151 allows the metal nanoparticles to remain longer inside the tube 152, and thus increases cooling efficiency. The diameter of the channel can be within a range of 1 mm to 50 mm. However, the size of the channel 151 can be adjusted according to the scale of the overall reaction system, and the concentration and amount of the precursor solution. Any of a variety of materials can be used for the channel 151 as necessary, such as glass, metal, plastic, alloys, etc.

The circulator 153 can supply any of a variety of cooling liquids to the tube 152, such as water, oil, alcohol, etc. A temperature controller 154 can be installed on the path through which such cooling liquid flows, and can measure the temperature of the cooling liquid in real time. The measured temperature can be used to control the flow of the circulator 153. As the rate of cooling for the metal nanoparticles during the post-treatment process can be adjusted using the temperature controller 154, the aging of the metal nanoparticles can be controlled.

A vibrator 155 can be coupled to the cooling unit 15. The vibrator 155 may emit high-frequency waves, and thus facilitate the flow of the metal nanoparticles. The vibrator 155 may be coupled to the tube 152. The vibrator 155 can vibrate the outer wall of the channel 151 or vibrate the metal nanoparticles directly, to allow the metal nanoparticles to readily flow within the tube 152.

Using the apparatus 10 for manufacturing metal nanoparticles according to an embodiment of the invention, it is possible to control the growth and grain size of the metal nanoparticles both by cooling and aging. If the metal nanoparticles that are to be synthesized have not undergone sufficient nucleation and growth during the heating operation, and thus are not of the desired size and size distribution, a setting can be made with the cooling unit 15 to provide an aging zone of an appropriate temperature, to adjust the size of the particles and control size distribution. The temperature can be adjusted to a value between −100 and 150° C.

The apparatus 10 for manufacturing metal nanoparticles according to this particular embodiment may utilize transport devices 12 for smooth flowing of the precursor solution. Examples of such transport devices 12 can include pumps. It is possible to install just one pump, but in cases where blockage occurs due to the agglomeration of nanoparticles, or where the flow of particles is not sufficient, several pumps may be installed.

According to certain aspects of the invention as set forth above, a cooling unit that includes a channel and a tube surrounding the channel can be coupled to the apparatus for manufacturing metal nanoparticles, whereby the cooling of the metal nanoparticles may be performed with greater efficiency. Also, a temperature controller, as well as a vibrating device, can be coupled to the cooling unit, to not only enable an aging process for the metal nanoparticles but also facilitate the flow of the metal nanoparticles.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An apparatus for manufacturing metal nanoparticles, the apparatus comprising:
a precursor supply unit configured to supply a precursor solution for metal nanoparticles;
a transport device configured to transport the precursor solution;
a heating unit connected with the precursor supply unit and configured to heat the precursor solution to a temperature range in which a production of metal nanoparticles occurs; and
a cooling unit connected with the heating unit and configured to collect and cool metal nanoparticles produced at the heating unit,
wherein the cooling unit comprises:
a channel;
a tube surrounding the channel; and
a circulator configured to supply a coolant to the tube.

2. The apparatus of claim 1, wherein a temperature controller is coupled to the cooling unit, the temperature controller configured to measure and control a temperature of the coolant.

3. The apparatus of claim 1, wherein a vibration device is coupled to the tube.
